(19) United States
(12) Patent Application Publication
(10) Pub. No.: US 2016/0306541 A1
(43) Pub. Date: Oct. 20, 2016

(54) OBJECT SWITCHING METHOD AND DEVICE, AND TOUCHSCREEN TERMINAL

(71) Applicant: ZTE CORPORATION, Shenzhen (CN)

(72) Inventor: Wen FANG, Shenzhen (CN)

(21) Appl. No.: 14/913,420

(22) PCT Filed: Oct. 22, 2013
(86) PCT No.: PCT/CN2013/085715

§ 371 Date: Jun. 19, 2016

(30) Foreign Application Priority Data
Aug. 22, 2013 (CN) 201310370858.2

(51) Int. Cl. G06F 3/0488; G06F 3/041; G06F 3/0481; G06F 3/0484

(52) U.S. Cl. CPC G06F 3/04883; G06F 3/04845; G06F 3/0418; G06F 3/0481; G06F 2203/04104; G06F 2203/04806; G06F 2203/04803

(57) ABSTRACT

Provided are an object switching method and apparatus, and a touch screen terminal. The object switching method includes: detecting, on an object display interface, that a user performs a multipoint touch control operation of zooming out and/or zooming in a currently displayed object on a touch screen; and judging whether the multipoint touch control operation satisfies a pre-set object switching condition, and when the multipoint touch control operation satisfies the pre-set object switching condition, switching the currently displayed object. The switching method can enable the user to directly switch the currently displayed object without switching to single-point touch control when performing an operation of zooming out and/or zooming in the object, thereby being able to improve the experience of the user browsing the object.

### TECHNICAL FIELD

The disclosure relates to the field of terminals, and in particular to an object switching method and apparatus, and a touch screen terminal.

### BACKGROUND

In the field of displaying and switching a picture file of a touch-control cellphone, the commonest manner at present is performing switching and presentation between adjacent pictures via a screen sliding operation, i.e., a user moving the previous or the next picture to be displayed on a screen by sliding left or right.

With regard to this operation mode, U.S. Pat. No. 7,864,163 of Apple Inc. performs definition and protection, and the main content of independent claims thereof may generally be summarized as: displaying, on a screen, a thumbnail image array corresponding to a group of pictures; after it is detected that a user contacts thumbnail images in the array, zooming in and displaying a contacted image; and selecting different photograph images according to a scrolling gesture moved horizontally by a user on the screen.

This operation and implementation methods are convenient and easy to be used for a user, but seem a little bit single on the diversity of the implementation effect. Firstly, the visual effect of a picture switched by the user can only be performed through left and right directions, and the visual effect of the picture switched in a direction in non-parallel to a screen edge cannot be displayed. In addition, at present, a multipoint touch control operation is gradually widely applied in cellphones. When performing the multipoint touch control, for example, zooming in or zooming out a picture, and if wanting to switch to a next picture, the user has to switch a multipoint operation mode to a single-point operation mode, which can inevitably bring inconvenience in actual use.

A more inconvenient case is that a user may often perform image dragging after a picture is zoomed in, so as to be able to clearly see a certain local part of the image; however, both of an image dragging operation and a switching image operation are simply the operations of sliding a screen actually, and therefore, a misoperation often happens that a user needs to drag an image, but after the image is dragged to an edge, an operation of switching to the next image is performed due to a little bit carelessness taken, which brings disordered and unpleasant operation experience to the user in use.

On the other hand, with respect to sliding to switch on the touch control cellphone, a more traditional switching method is that a left or right direction key or a virtual key on a screen is used to perform switching on adjacent images. This method is also inflexible, and meanwhile, with respect to the above-mentioned method of sliding to switch, it enables the user to perform switching among different operation modes more frequently, thereby interrupting the operation continuity of the user, thus is also not desirable.

Therefore, in large-screen touch control devices at present, a more flexible picture switching method with richer visual effects is required, so that it is not necessary for a user to often switch the modes in the operation on pictures, and relatively diversified display effects are provided according to operation details of the user, so as to improve the user experience when the user operates and browses the picture.

### SUMMARY

The main technical problem to be solved by the disclosure is to provide an object switching method and apparatus, and a touch screen terminal, thereby being able to improve the experience of a user browsing an object.

In order to solve the above-mentioned technical problem, the disclosure provides an object switching method, including:

detecting, on an object display interface, that a user performs a multipoint touch control operation of zooming out and/or zooming in a currently displayed object on a touch screen; and judging whether the multipoint touch control operation satisfies a pre-set object switching condition, and when the multipoint touch control operation satisfies the pre-set object switching condition, switching the currently displayed object.

Further, the object switching method further includes: performing zooming-out and/or zooming-in processing for the currently displayed object according to the multipoint touch control operation; wherein judging whether the multipoint touch control operation satisfies the pre-set object switching condition is performed in the process of performing zooming-out and/or zooming-in processing for the currently displayed object according to the multipoint touch control operation.

Further, the pre-set object switching condition is one of the following three switching conditions, or a combination of at least two of the following three switching conditions:

a first one, operating frequency of the multipoint touch control operation being within a pre-set frequency range;

a second one, a zooming-out proportion and/or zooming-in proportion corresponding to the multipoint touch control operation being within a pre-set proportion range; and

a third one, the number of operation times of the multipoint touch control operation being within a pre-set range of the number of times.

Further, switching the currently displayed object includes:

dividing an object to be switched-in into at least two constituent parts, each of constituent parts of the object to be switched-in entering the touch screen according to a first per-set manner, and being combined into an object and displayed;

or

a complete object to be switched-in entering the touch screen according to a second per-set manner and being displayed;

or

an object to be switched-in being displayed in a manner that the object to be switched-in is gradually zoomed in from one point on the touch screen.

Further, the first per-set manner includes: the each of constituent parts of the object to be switched-in entering the touch screen according to a direction of the multipoint touch control operation, and being combined into an object and displayed; and

the second per-set manner includes: the complete object to be switched-in entering the touch screen according to a direction of the multipoint touch control operation and being displayed.

Further, the multipoint touch control operation is a touch operation where the user contacts with the touch screen via at least two fingers, and zooms out and/or zooms in the currently displayed object on the touch screen by pinching and/or pullout; and dividing the object to be switched-in into two constituent parts includes:

detecting a central line of the touch operation of pinching and/or pullout, acquiring a proportion value between two parts of the currently displayed object which are divided by the central line, and dividing the object to be switched-in into two constituent parts in a corresponding proportion according to the proportion value;

or

detecting locations of points that the fingers of the user contact with the touch screen, and dividing the object to be switched-in into two constituent parts in a corresponding proportion according to the locations of the points;

or

detecting a length of a touch path where the fingers of the user pinch and/or pull out on the touch screen, and dividing the object to be switched-in into two constituent parts in a corresponding proportion according to the length of the touch path.

Further, the multipoint touch control operation is a touch operation where the user contacts with the touch screen via at least two fingers, and zooms out and/or zooms in the currently displayed object on the touch screen by pinching and/or pullout; before switching the currently displayed object, the method further includes: determining whether an object to be switched-in is a next object or a previous object of the currently displayed object; including:

detecting locations of points that the fingers of the user contact with the touch screen, and determining whether the object to be switched-in is the next object or the previous object of the currently displayed object according to the locations of the points;

or

detecting a length of a touch path where the fingers of the user pinch and/or pull out on the touch screen, and determining whether the object to be switched-in is the next object or the previous object of the currently displayed object according to the length of the touch path;

or

determining whether the object to be switched-in is the next object or the previous object of the currently displayed object according to whether the multipoint touch control operation is pinching or pullout.

Further, the object includes: a picture, a document or an information display page.

In order to solve the above-mentioned technical problem, the disclosure further provides an object switching apparatus, including: a detection component and an object switching component,

wherein the detection component is configured to detect, on an object display interface, that a user performs a multipoint touch control operation of zooming out and/or zooming in a currently displayed object on a touch screen; and the object switching component is configured to judge whether the multipoint touch control operation satisfies a pre-set object switching condition, and when the multipoint touch control operation satisfies the pre-set object switching condition, switch the currently displayed object.

Further, the object switching apparatus further includes: an object processing component,

wherein the object processing component is configured to perform zooming-out and/or zooming-in processing for the currently displayed object according to the multipoint touch control operation; and

the object switching component is configured to judge whether the multipoint touch control operation satisfies the pre-set object switching condition in the process that the object processing component performs the zooming-out and/or zooming-in processing for the currently displayed object.

Further, the multipoint touch control operation is a touch operation where the user contacts with the touch screen via at least two fingers, and zooms out and/or zooms in the currently displayed object on the touch screen by pinching and/or pullout.

Further, the pre-set object switching condition is one of the following three switching conditions, or a combination of at least two of the following three switching conditions:

a first one, operating frequency of the multipoint touch control operation being within a pre-set frequency range;

a second one, a zooming-out proportion and/or zooming-in proportion corresponding to the multipoint touch control operation being within a pre-set proportion range; and

a third one, the number of operation times of the multipoint touch control operation being within a pre-set range of the number of times.

Further, the object switching component is configured to:

divide an object to be switched-in into at least two constituent parts, enable each of constituent parts of the object to be switched-in to enter the touch screen according to a first per-set manner, and to be combined into an object and displayed;

or

enable a complete object to be switched-in to enter the touch screen according to a second per-set manner and to be displayed;

or

enable an object to be switched-in to be displayed in a manner that the object to be switched-in is gradually zoomed in from one point on the touch screen.

Further, the first per-set manner includes: the each of constituent parts of the object to be switched-in entering the touch screen according to a direction of the multipoint touch control operation, and being combined into an object and displayed; and

the second per-set manner includes: the complete object to be switched-in entering the touch screen according to a direction of the multipoint touch control operation and being displayed.

Further, the multipoint touch control operation is a touch operation where the user contacts with the touch screen via at least two fingers, and zooms out and/or zooms in the currently displayed object on the touch screen by pinching and/or pullout; and the object switching component is configured to:

detect a central line of the touch operation of pinching and/or pullout, acquire a proportion value between two parts of the currently displayed object which are divided by the central line, and divide the object to be switched-in into two constituent parts in a corresponding proportion according to the proportion value;

or

detect locations of points that the fingers of the user contact with the touch screen, and divide the object to be switched-in into two constituent parts in a corresponding proportion according to the locations of the points;

or

detect a length of a touch path where the fingers of the user pinch and/or pull out on the touch screen, and divide the object to be switched-in into two constituent parts in a corresponding proportion according to the length of the touch path.

Further, the multipoint touch control operation is a touch operation where the user contacts with the touch screen via at least two fingers, and zooms out and/or zooms in the currently displayed object on the touch screen by pinching and/or pullout; and the object switching component is further configured to detect locations of points that the fingers of the user contact with the touch screen, and determine whether the object to be switched-in is a next object or a previous object of the currently displayed object according to the locations of the points; or detect a length of a touch path where the fingers of the user pinch and/or pull out on the touch screen, and determine whether the object to be switched-in is a next object or a previous object of the currently displayed object according to the length of the touch path; or determine whether the object to be switched-in is a next object or a previous object of the currently displayed object according to whether the multipoint touch control operation is pinching or pullout.

In order to solve the above-mentioned technical problem, the disclosure further provides a touch screen terminal, including: the object switching apparatus as stated above.

The beneficial effects of the disclosure are:

the disclosure provides an object switching method and apparatus, and a touch screen terminal, which can improve the experience of a user browsing an object. The object switching method of the disclosure includes: detecting, on an object display interface, that a user performs a multipoint touch control operation of zooming out and/or zooming in a currently displayed object on a touch screen; and judging whether the multipoint touch control operation satisfies a pre-set object switching condition, and when the multipoint touch control operation satisfies the pre-set object switching condition, switching the currently displayed object. The switching method of the disclosure can enable a user to directly switch an object without switching to a single-point touch control operation when performing an operation of zooming out and/or zooming in a currently displayed object, so that the operations related with object browsing of the user are more smooth, fast and convenient, and meanwhile, since it is not necessary to switch to single-point touch control operation, a problem that a misoperation is caused due to the same operation between both of object local part dragging and inter-object switching is avoided. Compared with traditional switching methods, the switching method of the disclosure can improve the convenience for the user to operate an object and improve the experience when browsing the object. For example, when the object is a picture, the switching method of the disclosure can enable the user to directly switch the picture without switching to a single-point touch control operation when performing an operation of zooming out and/or zooming in a currently displayed picture, so that the operations related with picture browsing of the user are more smooth, fast and convenient.

### BRIEF DESCRIPTION OF THE DRAWINGS

FIG. 1 is a schematic flowchart of a picture switching method provided by Embodiment I of the disclosure;

FIG. 2 is a schematic flowchart of another picture switching method provided by Embodiment I of the disclosure;

FIG. 3 is a schematic diagram of a pinching touch action on a touch screen performed by a user provided by Embodiment I of the disclosure;

FIG. 4 is a schematic diagram of zooming out a picture 1 by pinching provided by Embodiment I of the disclosure;

FIG. 5 is a schematic diagram of enabling a picture 2 to switch into a screen provided by Embodiment I of the disclosure;

FIG. 6 is a schematic diagram of displaying a picture 2 provided by Embodiment I of the disclosure;

FIG. 7 is another schematic diagram of a pinching touch action on a touch screen performed by a user provided by Embodiment I of the disclosure;

FIG. 8 is another schematic diagram of enabling a picture 2 to switch into a screen provided by Embodiment I of the disclosure;

FIG. 9 is another schematic diagram of a pinching touch action on a touch screen performed by a user provided by Embodiment I of the disclosure;

FIG. 10 is another schematic diagram of enabling a picture 2 to switch into a screen provided by Embodiment I of the disclosure;

FIG. 11 is a schematic diagram of zooming out a picture 2 by pinching provided by Embodiment I of the disclosure;

FIG. 12 is a schematic diagram of enabling a picture 1 to switch into a screen provided by Embodiment I of the disclosure;

FIG. 13 is another schematic diagram of a pinching touch action on a touch screen performed by a user provided by Embodiment I of the disclosure;

FIG. 14 is a schematic diagram of enabling a picture 2 next to a picture 1 to switch into a screen provided by Embodiment I of the disclosure;

FIG. 15 is another schematic diagram of a pinching touch action on a touch screen performed by a user provided by Embodiment II of the disclosure;

FIG. 16 is a schematic diagram of enabling a picture 1 prior to a picture 2 to switch into a screen provided by Embodiment I of the disclosure;

FIG. 17 is a schematic diagram of zooming out a short message conversation page 1 by pinching provided by Embodiment I of the disclosure;

FIG. 18 is a schematic diagram of enabling a short message conversation page 2 to switch into a screen provided by Embodiment I of the disclosure;

FIG. 19 is a structural schematic diagram of an object switching apparatus provided by Embodiment II of the disclosure;

FIG. 20 is another structural schematic diagram of an object switching apparatus provided by Embodiment II of the disclosure; and

FIG. 21 is a structural schematic diagram of a terminal provided by Embodiment II of the disclosure.

### DETAILED DESCRIPTION

The disclosure will further be described in detail with reference to the accompanying drawings and specific embodiments hereinafter.

The core concept of the disclosure is: detecting, on an object display interface, that a user performs a multipoint touch control operation of zooming out and/or zooming in a currently displayed object on a touch screen; and judging whether the multipoint touch control operation satisfies a pre-set object switching condition, and when the multipoint touch control operation satisfies the pre-set object switching condition, switching the currently displayed object. Through the technical solution, the user can realize object switching via a multipoint touch control operation when browsing the object, and thus it is not necessary to switch to a single-point touch control operation to realize the object switching. The object of the disclosure may include: a picture, a document or an information display page and so on. Since picture switching is often used by a user, the object switching method of the disclosure will be introduced by taking an object as a picture hereinafter.

### Embodiment I

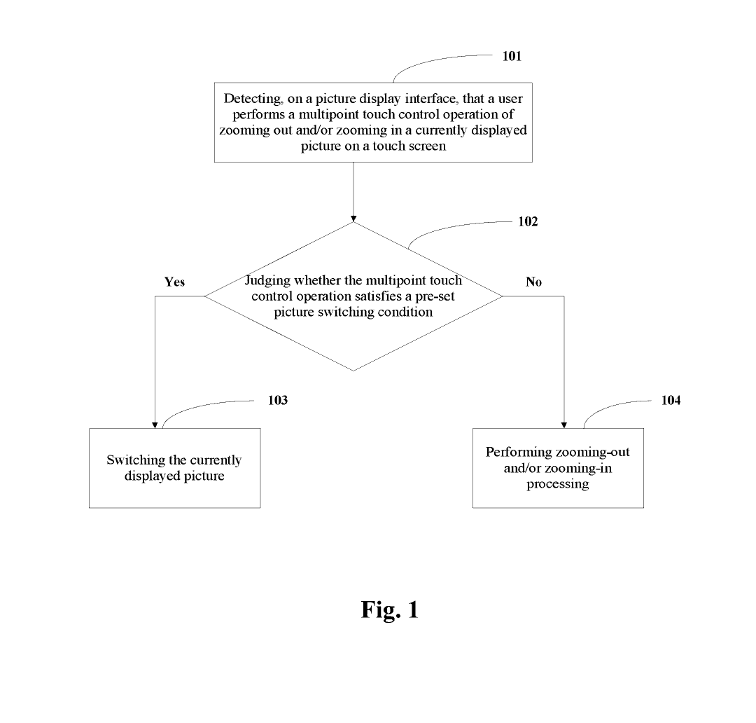

as shown in FIG. 1, the present embodiment provides a picture switching method, including the following steps:

step 101: detecting, on a picture display interface, that a user performs a multipoint touch control operation of zooming out and/or zooming in a currently displayed picture on a touch screen;

step 102: judging whether the multipoint touch control operation satisfies a pre-set picture switching condition, and when the multipoint touch control operation satisfies the pre-set picture switching condition, performing step 103, and when the multipoint touch control operation does not satisfy the pre-set picture switching condition, performing step 104;

step 103: switching the currently displayed picture; and

step 104: performing zooming-out and/or zooming-in processing.

The picture switching method of the present embodiment can enable a user to directly switch a picture without switching to a single-point touch control operation when performing an operation of zooming out and/or zooming in a picture, so that the operations related with picture browsing of the user are more smooth, fast and convenient. For example, when the user adopts a multipoint touch control operation to zoom in a currently displayed picture, when it is judged that the multipoint touch control operation satisfies a pre-set operation, the picture will be switched, so that it is not necessary for the user to perform switching from multipoint touch control operation to single-point touch control operation to switch the picture. Meanwhile, the use of the switching method of the present embodiment of the disclosure can avoid the problem that a misoperation is caused due to the same operation between both of picture local part dragging and inter-picture switching. Compared with traditional picture switching methods, the picture switching method of the disclosure can improve the convenience for the user to operate a picture and improve the experience when browsing the picture.

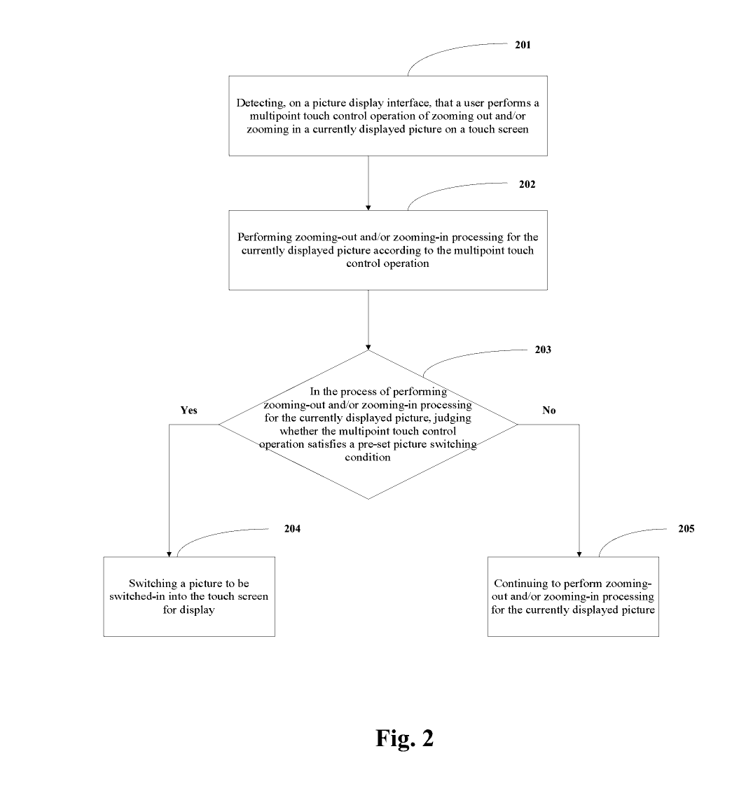

The picture switching method of the present embodiment may further include: a step of performing zooming-out and/or zooming-in processing for the currently displayed picture according to the multipoint touch control operation. The step of zooming out and/or zooming in the picture, and the process of judging whether the switching condition is satisfied may be two parallel processes, and there are many time sequential relationships between the two processes above, for example, the judging step is able to be performed before the step of zooming-out and/or zooming-in, or the judging step is able to be performed after the step of zooming-out and/or zooming-in, or the judging step is able to be performed in the process of performing the step of zooming-out and/or zooming-in. As shown in FIG. 2, the picture switching method of the present embodiment includes the following steps:

step 201: detecting, on a picture display interface, that a user performs a multipoint touch control operation of zooming out and/or zooming in a currently displayed picture on a touch screen;

step 202: performing zooming-out and/or zooming-in processing for the currently displayed picture according to the multipoint touch control operation;

step 203: in the process of performing zooming-out and/or zooming-in processing for the currently displayed picture, judging whether the multipoint touch control operation satisfies a pre-set picture switching condition, and when the multipoint touch control operation satisfies the pre-set picture switching condition, performing step 204, and when the multipoint touch control operation does not satisfy the pre-set picture switching condition, performing step 205;

step 204: switching a picture to be switched-in into the touch screen for display; and

step 205: continuing to perform zooming-out and/or zooming-in processing for the currently displayed picture.

It can be seen from steps 201-205 that in the picture switching method of the present embodiment, the process of detecting whether the switching condition is satisfied and the process of zooming out and/or zooming in the picture are parallel, and the two processes may be performed simultaneously. Certainly, the switching method of the present embodiment may also be: when a multipoint touch control operation for zooming out and/or zooming in a currently displayed picture performed by a user on a touch screen is detected, firstly detecting whether the switching condition is satisfied, and when the switching condition is satisfied, directly performing switching while a terminal does not perform the operations of zooming-out and/or zooming-in, and when the switching condition is not satisfied, performing the operations of zooming out and/or zooming in the picture by the terminal. In brief, the time sequence between the two processes is not limited.

Through the application of the picture switching method of the present embodiment, the terminal may switch the picture in the process of performing zooming-out and/or zooming-in processing for the picture. For a user, the user can directly switch the picture without switching to single-point touch control when performing a multipoint touch control operation of zooming out and/or zooming in the picture, so that the operations related with picture browsing of the user are more smooth, fast and convenient. For example, when a user adopts a multipoint touch control operation to perform a multipoint operation of zooming out a currently displayed picture, if a trace of the multipoint touch control operation satisfies a pre-set operation trace at a certain time while the picture is zoomed out, the picture will be switched, which can realize that the user can switch the picture without switching an operation mode during zooming out the picture. Meanwhile, the use of the switching method of the present embodiment of the disclosure can avoid the problem that a misoperation is caused due to the same operation between both of picture local part dragging and inter-picture switching.

The multipoint touch control operation in the present embodiment may be a classical operation, i.e., a touch operation of pinching and/or pullout on a touch screen by at least two fingers, for example, zooming out the picture by the pinching of two fingers, and zooming in the picture by the pullout of two fingers. Therefore, in steps 101 and 201 mentioned above, the multipoint touch control operation is a touch operation where the user contacts with the touch screen via at least two fingers and performs pinching and/or pullout of zooming out and/or zooming in the currently displayed picture on the touch screen. Certainly, the multipoint touch control operation in the present embodiment may also be other types of multipoint touch operation. The object switching method of the present embodiment will be further introduced by taking the multipoint touch control operation as the classical multipoint touch operation hereinafter.

In the case where the touch operation is used to zoom out and/or zoom in the picture, in step 103 mentioned above, the step of judging whether the multipoint touch control operation satisfies the pre-set picture switching condition is: detecting whether the touch operation of pinching and/or pullout satisfies the pre-set picture switching condition.

The pre-set picture switching condition in the present embodiment may be set according to the touch operation of zooming out and zooming in the picture preformed by the user, and when the user performs an operation of zooming out and zooming in the picture, if a certain aspect of the zooming-out and zooming-in operation exceeds a pre-set threshold value, the existing picture in displaying is switched to a picture adjacent to the existing picture so as to be displayed on a screen. In the switching method of the present embodiment, when a user zooms out and/or zooms in a picture via a touch operation of pinching and/or pullout, it may be judged whether switching is needed by detecting whether operating frequency of the touch operation of pinching and/or pullout is within a pre-set range; for example, when the operating frequency of the touch operation of the current pinching and/or pullout is greater than a certain pre-set frequency, picture switching is performed; it may also be judged whether the picture is needed to be switched by detecting whether a zooming-out proportion and/or zooming-in proportion corresponding to the touch operation of pinching and/or pullout is within a pre-set range, for example, when the zooming-out and/or zooming-in proportion corresponding to the touch operation of the current pinching and/or pullout is greater than a pre-set proportion value, picture switching is performed; and it may also be judged whether switching is needed by detecting whether the number of operation times of the touch operation of pinching and/or pullout is within a pre-set range, for example, when a total number of operation times of pinching and/or pullout is greater than a pre-set number of operation times, picture switching is performed. In brief, the switching condition of the present embodiment may be set according to the characteristics of the touch operation adopted by a user in zooming out and zooming in a picture. Therefore, the pre-set picture switching condition of the present embodiment is one of the following three switching conditions or a combination of at least two of the following three switching conditions:

the first one, operating frequency of the touch operation of pinching and/or pullout being within a pre-set frequency range;

the second one, a zooming-out proportion and/or zooming-in proportion corresponding to the touch operation of pinching and/or pullout being within a pre-set proportion range; and

the third one, the number of operation times of the touch operation of pinching and/or pullout being within a pre-set range of the number of times.

The pre-set picture switching condition of the present embodiment may be a single switching condition, or may be a combined switching condition, wherein the single switching condition is one pre-set picture switching condition, and may be one of the three pre-set picture switching conditions above, and a picture may be switched as long as one of the above-mentioned three pre-set picture switching conditions is satisfied. For example, when it is detected that operating frequency of the touch operation of the current pinching and/or pullout satisfies a pre-set frequency range, a terminal may perform picture switching.

In order to ensure the accuracy of switching a picture and prevent a misoperation, the pre-set picture switching condition of the present embodiment may be the combined switching condition, which is constituted by a plurality of switching conditions. The combined switching condition may be formed by combining at least two switching conditions of the three pre-set picture switching conditions above. For example, the combined switching condition may be: the operating frequency of the touch operation of pinching and/or pullout being within a pre-set frequency range, and the zooming-out proportion and/or zooming-in proportion corresponding to the touch operation of pinching and/or pullout satisfying a pre-set proportion range; and when both of the two conditions are satisfied simultaneously, picture switching is performed. Under the combined switching condition, the judging process is: firstly judging whether the operating frequency of the touch operation of pinching and/or pullout is within the pre-set frequency range, and then judging whether the zooming-out proportion and/or zooming-in proportion corresponding to the touch operation of pinching and/or pullout is within the pre-set proportion range.

The application of the picture switching method of the present embodiment can directly switch a picture without switching an operation to a single-point operation when a user adopts a multipoint touch control operation to perform zooming-out and/or zooming-in, thereby improving the experience of the user browsing the picture.

The process of switching a picture during zooming out and/or zooming in the picture will be introduced respectively hereinafter.

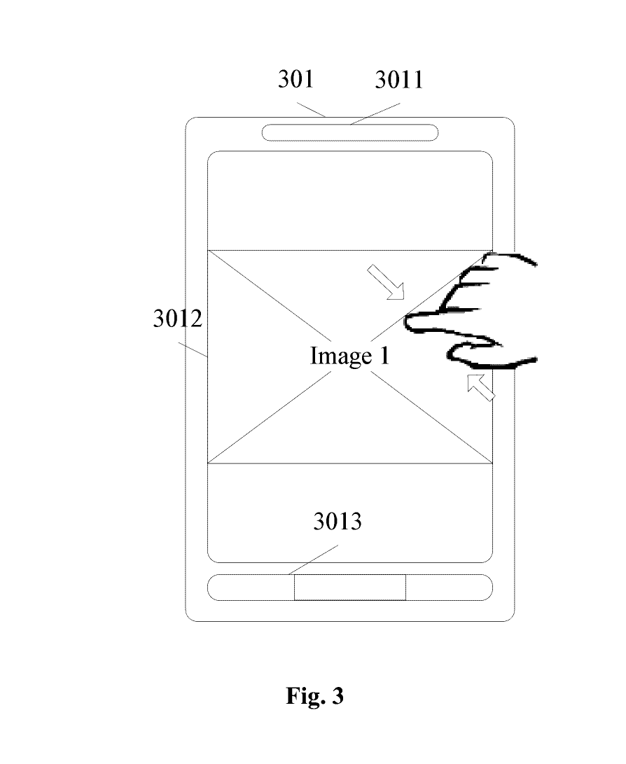

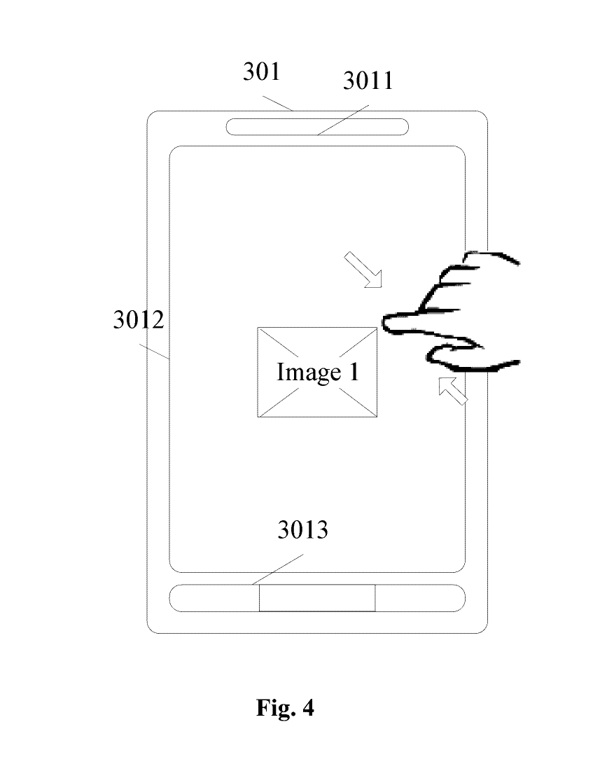

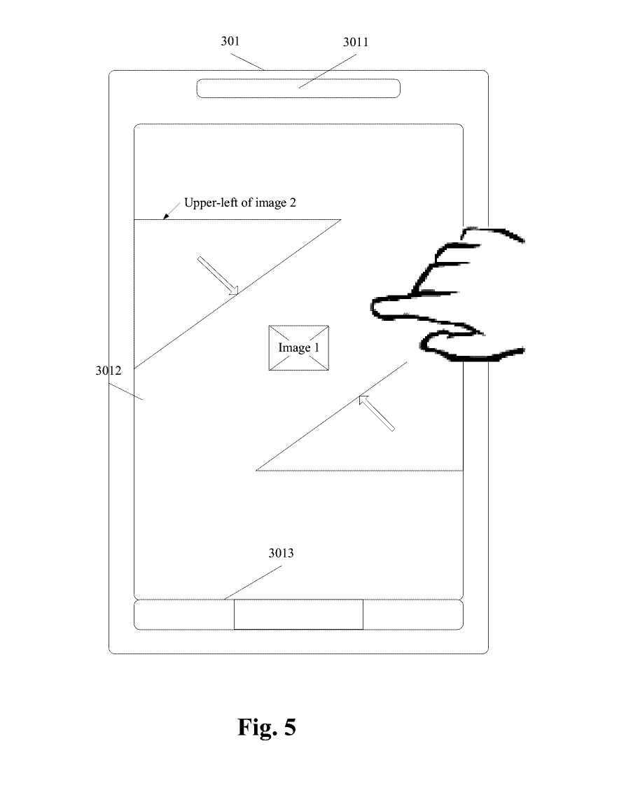

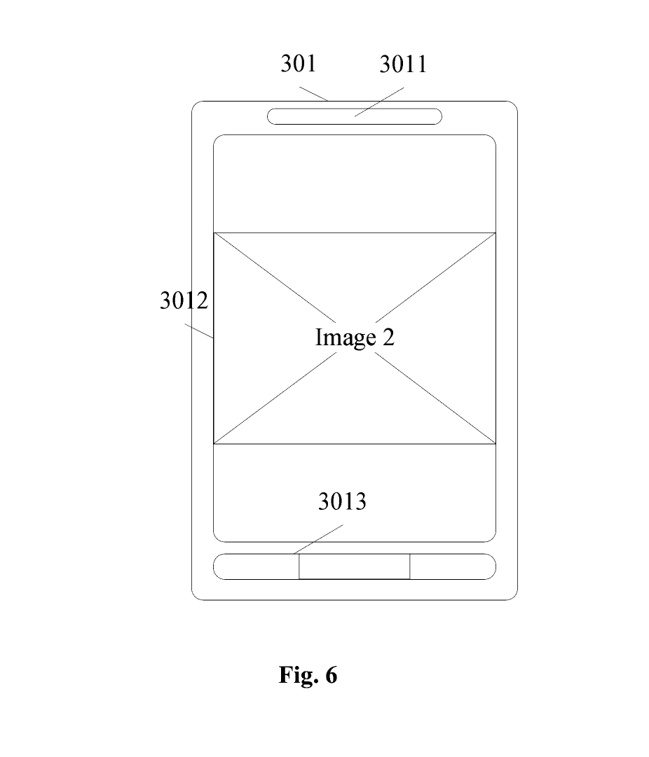

In a first scenario, a user contacts with a touch screen via two fingers, and performs a touch action of pinching on a currently displayed picture on the touch screen; at this time, the currently displayed picture will gradually become small along with the pinching of the fingers, and when a zooming-out limit of the picture corresponding to the pinching action of the fingers reaches a pre-set limit, a terminal will switch a new picture to the touch screen for display so as to complete picture switching, and when the zooming-out limit of the picture corresponding to the pinching action does not reach the pre-set limit, the currently displayed picture continues to be zoomed out. After a picture is zoomed out to a lower limit as described in FIGS. 3-6, if the zooming-out operation continues, the process of picture switching is started. In particular, as shown in FIG. 3, when an image 2 is displayed normally on a touch control screen 3012 of a portable mobile device 301, a user performs a touch operation of pinching respectively from the bottom right to the upper-left in a two-point operation according to the directions shown in the figures so as to perform the zooming-out operation on an image 1. As shown in FIG. 4, at this time, the image 1 has been zoomed out to the minimum threshold value in a normal case, and the user continues to perform the zooming-out operation of pinching in a bottom right and upper-left manner. As shown in FIGS. 5 and 6, the response of the terminal of the present embodiment to the zooming-out operation is: the image 1 continuing to be zoomed out until it disappears, and meanwhile, the image 2 adjacent to the image 1 being respectively divided into two parts to enter the touch screen from the upper-left and the bottom right according to an operation direction of the zooming-out operation of the user, and being combined in a middle part, so as to complete the switching and displaying of replacing the image 1 with the image 2. In this scenario, the picture may be switched only when the user zooms out the picture. In FIGS. 3-6, 301 refers to a first portable mobile device, 3011 refers to a speaker on the portable mobile device 301, 3012 refers to a touch control screen on the portable mobile device 301, and 3013 refers to a function key on the portable mobile device 301.

In a second scenario, a user contacts with a touch screen via two fingers, and performs a touch action of pullout on a currently displayed picture on the touch screen; at this time, the currently displayed picture will gradually become big along with the pullout of the fingers, and when a zooming-in limit of the picture corresponding to the pullout action of the fingers reaches a pre-set limit, a terminal will switch a new picture to the touch screen for display so as to complete picture switching. When the zooming-in limit of the picture corresponding to the pullout action does not reach the pre-set limit, the currently displayed picture continues to be zoomed in. The switching process under the present scenario is similar with the first scenario, and reference may be made to FIGS. 3-6. In this scenario, the picture may be switched only when the user zooms in the picture.

In a third scenario, a user contacts with a touch screen via two fingers, and performs a touch action of pinching and pullout on a currently displayed picture on the touch screen so as to zoom out and zoom in the picture, and when the touch action of pinching is performed on the currently displayed picture, the currently displayed picture will gradually become small along with the pinching of the fingers, and when the touch action of pullout is performed on the currently displayed picture, the currently displayed picture will gradually become big along with the pullout of the fingers. When the user zooms out the picture, reference is made to the switching process of the first scenario; when the user zooms in the picture, reference is made to the switching process of the second scenario; and when the user firstly zooms out and then zooms in the picture, that is the user firstly performs a pinching action and then performs a pullout action on the picture, it may be detected whether a time interval between the pinching action and the pullout action satisfies a pre-set time threshold value, and when the time interval between the pinching action and the pullout action satisfies the pre-set time threshold value, the picture is switched. In this scenario, when the user performs two processes of both zooming out the picture and zooming in the picture, the picture may be switched.

The picture switching method of the present embodiment can enable a user to directly switch a picture without switching to single-point touch control when zooming out and/or zooming in the picture, so that the operations related with picture browsing of the user are more smooth, fast and convenient, so that it is not necessary for the user to perform switching from multipoint touch control to the single-point touch control to switch the picture; and meanwhile, the use of the switching method of the present embodiment of the disclosure can avoid a problem that a misoperation is caused due to the same operation between both of picture local part dragging and inter-picture switching.

The picture switching method of the present embodiment further introduces the specific process of switching a picture, and user experience can be further increased by setting different effects of switching a picture to be switched-in. Therefore, in step 103 or 204 mentioned above, the step of switching the picture may include the following three processes.

In the first process, the picture to be switched-in is divided into at least two constituent parts, each of constituent parts of the picture to be switched-in enters the touch screen according to a first per-set manner, and is combined into a picture and displayed.

This method of switching in a picture to be switched-in is mainly that when a switching condition is triggered, the picture to be switched-in is divided into at least two parts, so that each of parts of the picture to be switched-in enters the touch screen in a pre-set manner and then is combined into the picture to be switched-in and displayed. For example, when the switching condition is triggered, the picture to be switched-in is divided into a plurality of constituent parts, so that the each of constituent parts of the picture to be switched-in enters the touch screen according to the direction of a touch operation of pinching and/or pullout and is combined into the picture to be switched-in and displayed, or two constituent parts of the picture to be switched-in are displayed after entering the touch screen from pre-set two different directions and being combined into the picture to be switched-in. The first per-set manner in the present embodiment includes: the each of constituent parts of the picture to be switched-in entering the touch screen according to the direction of a touch operation of pinching and/or pullout and being combined into the picture and displayed, or entering the touch screen from a fixed direction and being displayed. For example, when two fingers perform a zooming-out operation by pinching on a picture, two constituent parts of a picture to be switched-in will enter the touch screen according to the direction of finger pinching, or when two fingers perform a zooming-in operation by pulling out on the picture, the two constituent parts will enter the touch screen according to the direction of a straight line formed by contact points of the two fingers, or when the operations of several times of pinching and several times of pullout are performed on the picture, the direction of a straight line formed by contact points of the two fingers during the last operation is taken to enter the touch screen or enter the touch screen by taking the direction of a sliding straight line.

In the second process, a complete picture to be switched-in enters a touch screen according to a second per-set manner and is displayed.

This method of switching in a picture to be switched-in is mainly that the picture to be switched-in enters a touch screen for display in a complete manner according to a pre-set direction, for example, the complete picture to be switched-in enters the touch screen according to the direction of a touch operation of pinching and/or pullout and is displayed, or for example, the picture to be switched-in is able to enter the touch screen from any edge of four edges of the touch screen for display.

In the third process, the object to be switched-in is displayed in a manner that the object to be switched-in is gradually zoomed in from one point on the touch screen.

This method of switching in a picture to be switched-in is mainly that the whole touch screen is gradually filled by taking a certain point on a display screen as a starting point, for example, spreading the whole touch screen from a certain point that a certain finger contacts with the touch screen for display.

By taking the first switching-in method of a picture to be switched-in mentioned above as an example, the process of the picture to be switched-in switching in a touch screen for display in the disclosure will be specifically explained hereafter.

In the first switching-in method, the process of dividing the picture to be switched-in into at least two constituent parts may include the following cases.

1. A central line of the touch operation of pinching and/or pullout is detected, a proportion value of the central line dividing the currently displayed picture into two parts is acquired, and the object to be switched-in is divided into two constituent parts in a corresponding proportion according to the proportion value.

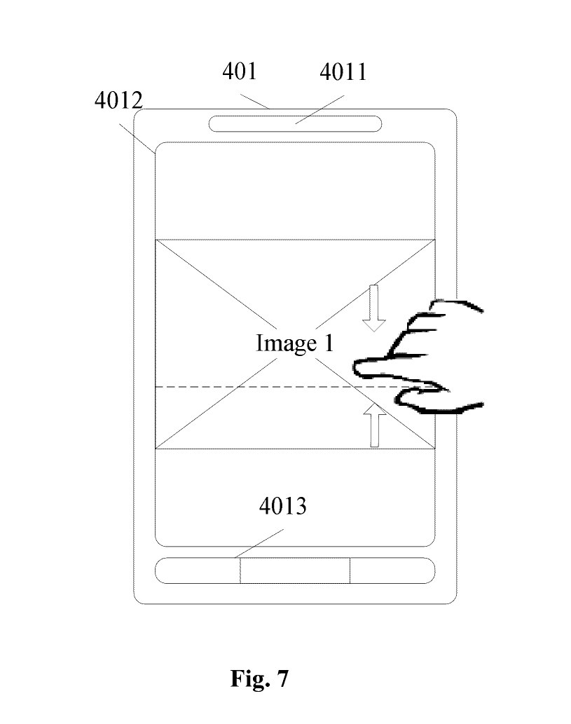

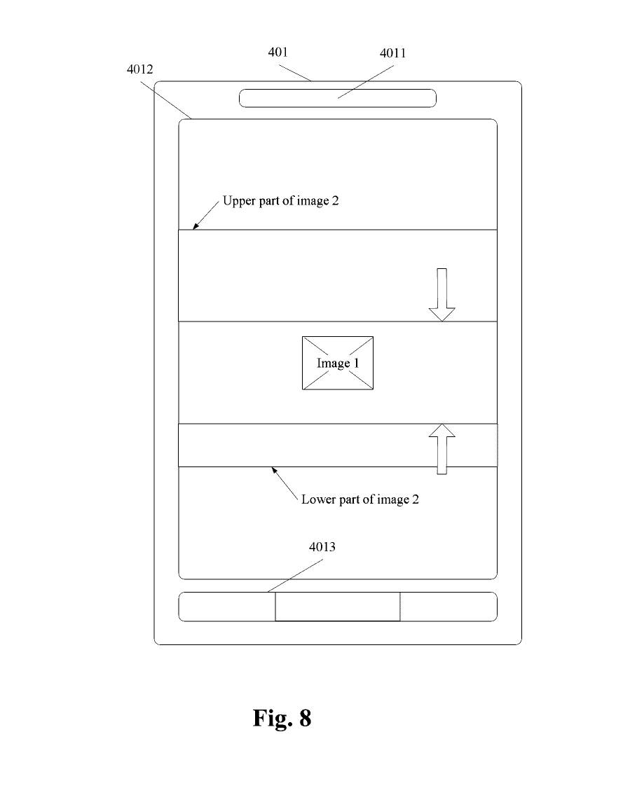

As shown in FIG. 7, a user performs a zooming-out operation on a picture via two fingers pinching up and down, and if the user continues the operation after a zooming-out threshold value is satisfied, a picture switching condition will be triggered. When the picture switching is triggered, a horizontal straight line where a touch control operation centre of the user is located divides the whole picture region into upper and lower parts in different proportions. As shown in FIG. 8, the picture to be switched-in is also divided into two parts in different proportions according to the different proportions, which respectively enter a picture display region from above and below, and are finally combined into a complete picture in the location of “the straight line where the operation centre is located” of the left figure. By controlling the proportion of images of different parts according to the location of user operation, a sense that two parts are respectively pulled out by two fingers to be combined into a picture at an operational point is brought to the user in the visual effect. In FIGS. 7 and 8, 401 refers to a second portable mobile device, 4011 refers to a speaker on the portable mobile device 401, 4012 refers to a touch control screen on the portable mobile device 401, and 4013 refers to a function key on the portable mobile device 401.

2. The locations of points that the fingers of the user contact with the touch screen are detected, and the picture to be switched-in is divided into two constituent parts in a corresponding proportion according to the locations of the points.

For example, as shown in FIG. 7, the picture to be switched-in is divided into two constituent parts in a corresponding proportion according to positions of touch screen points of an index finger and a thumb on the screen. In FIG. 6, the positions of the touch screen points of the index finger and the thumb on the screen are below a central line of the screen, and at this time, the picture to be switched-in may be divided into two constituent parts according to a pre-set proportion.

3. A length of a touch path where the fingers of the user pinch and/or pull out on the touch screen is detected, and the picture to be switched-in is divided into two constituent parts in a corresponding proportion according to the length of the touch path.

For example, in FIG. 7, the size of the path of the index finger sliding and the size of the path of the thumb sliding may be acquired, and the proportion of dividing the picture to be switched-in may be determined according to the proportion of the two paths.

In the first switching-in method mentioned above, the step of each of constituent parts of the picture to be switched-in entering the touch screen according to the direction of a touch operation of pinching and/or pullout and being combined into the picture to be switched-in and displayed may include: two constituent parts of the picture to be switched-in entering the screen according to the direction of the touch operation of pinching and/or pullout and being combined into the picture and displayed. As shown in FIGS. 5 and 8, two parts of the picture to be switched-in respectively enter the touch screen from a sliding direction of the index finger and a sliding direction of the thumb finger.

The picture switching method of the present embodiment, before switching the picture, further includes: a process of determining whether the picture to be switched-in is a previous picture or a next picture of the currently displayed picture. The process may include:

1. Locations of points that the fingers of the user contact with the touch screen are detected, and it is determined whether the picture to be switched-in is the next picture or the previous picture of the currently displayed picture according to the locations of the points.

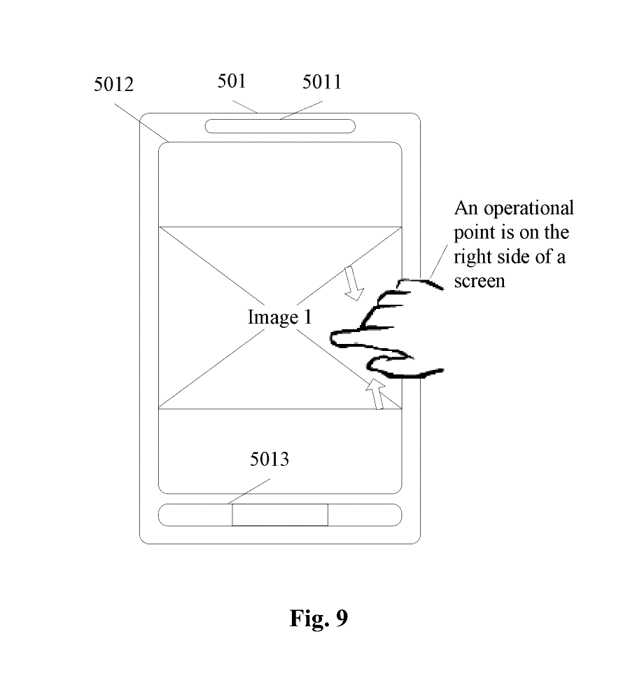

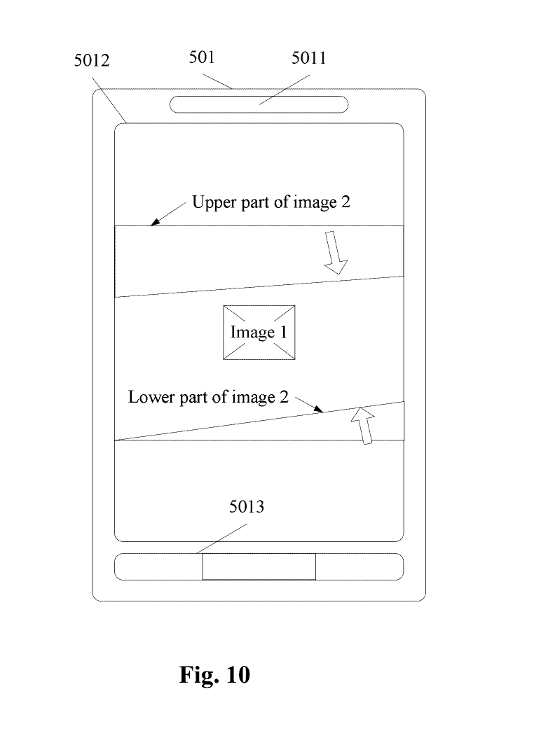

As shown in FIGS. 9-12, it is the illustration of judging that the previous picture or the next picture is switched according to the locations of the points; and in FIGS. 9-12, the image 2 is the next picture of the image 1. In FIGS. 9-12, 501 refers to a third portable mobile device, 5011 refers to a speaker on the portable mobile device 501, 5012 refers to a touch control screen on the portable mobile device 501, and 5013 refers to a function key on the portable mobile device 501.

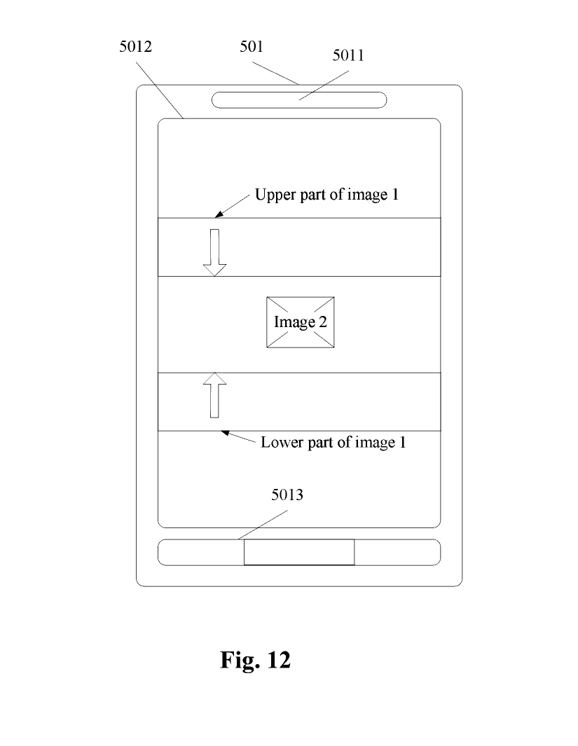

As shown in FIGS. 9 and 12, when the locations of the points are on the left side of the screen, and the user triggers picture switching according to the method stated in the disclosure, it is automatically judged as switching to the next picture image 2 of the image 1.

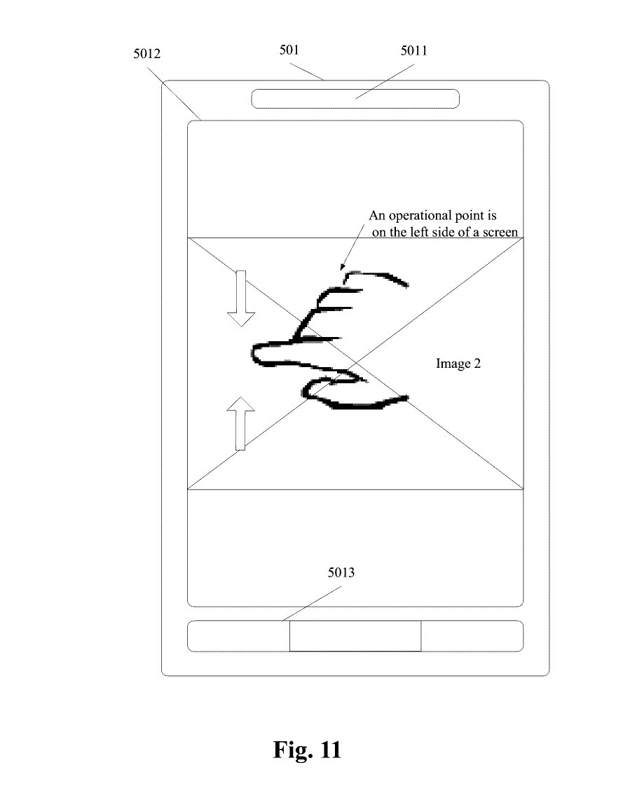

As shown in FIGS. 11 and 12, after switching, when the locations of the points are on the right side of the screen, and the user triggers picture switching according to the method stated in the disclosure, it is automatically judged as switching to the previous picture image 1 of the image 2.

The present embodiment proposes that it is judged to switch to the previous picture or the next picture by taking a left or right location of an operational point, and in conjunction with the case of judging the combined proportion of two parts of picture by taking the location of the operational point, which is proposed in the embodiment above, a complete implementation scheme can be formed.

2. A length of a touch path where the fingers of the user pinch and/or pull out on the touch screen is detected, and it is determined whether the picture to be switched-in is the next picture or the previous picture of the currently displayed picture according to the length of the touch path.

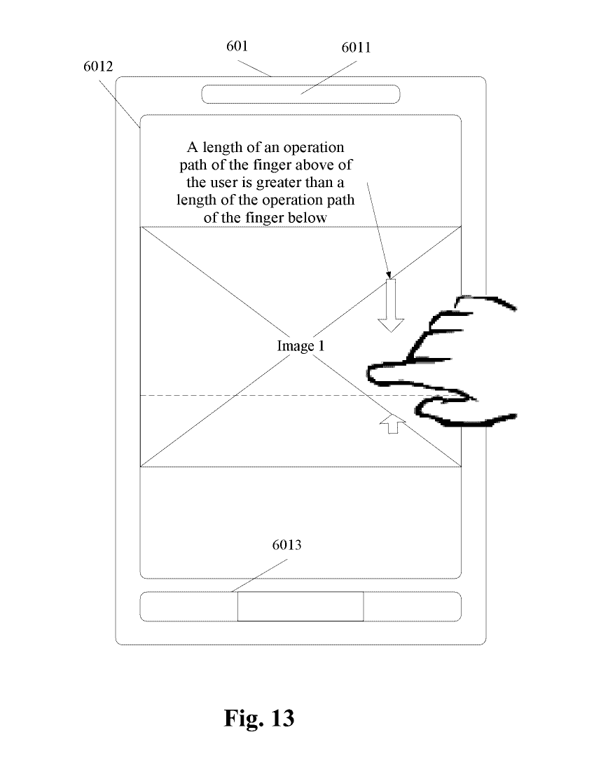

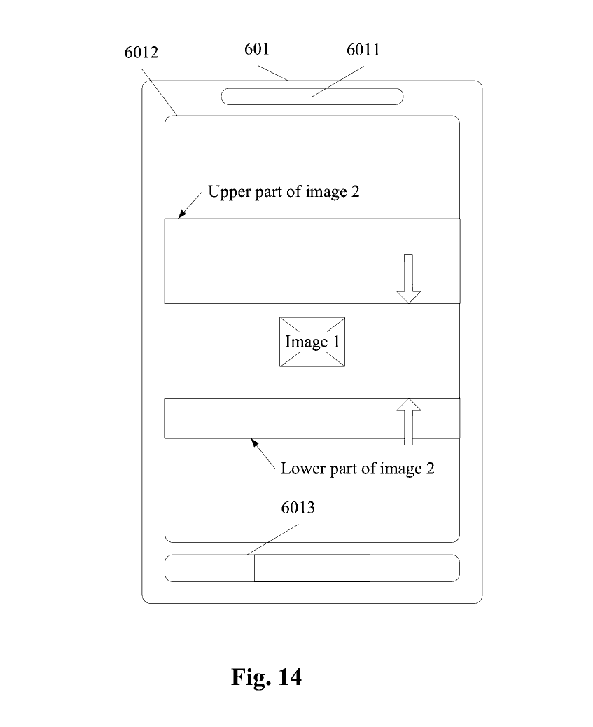

As shown in FIGS. 13 and 14, the image 2 is an image after the image 1. In two pictures above and two pictures below, the operation of user fingers has one remarkable difference, i.e. in FIG. 13, a length of an operation path of the finger above of the user is greater than a length of the operation path of the finger below. FIG. 14 is a response to FIG. 13, and when the user performs a zooming-out operation, a touch control device automatically records the lengths of the operation paths of the two fingers, and if the length of the operation path of the finger above is greater than the length of the operation path of the finger below, it is automatically switched to the next picture of the currently displayed picture, i.e. the image 2 in the top-right figure.

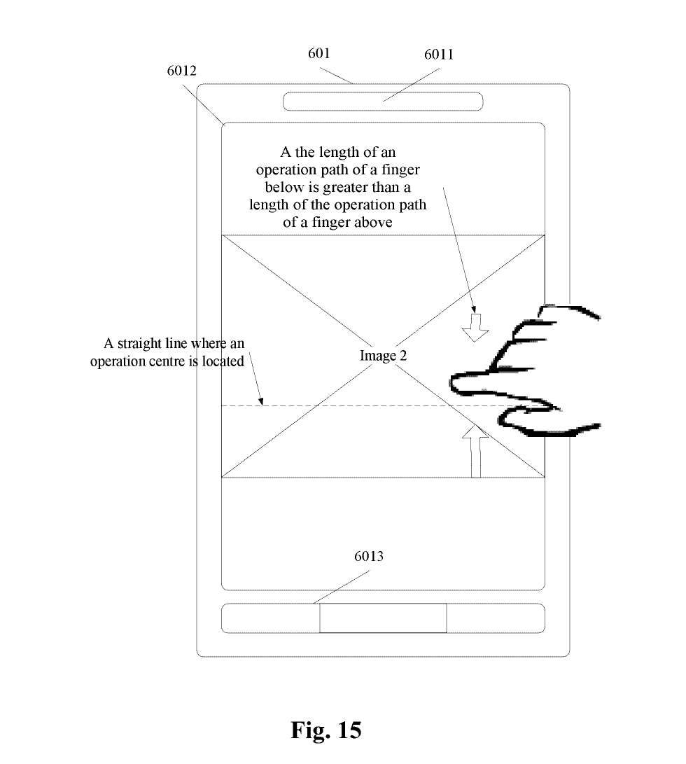

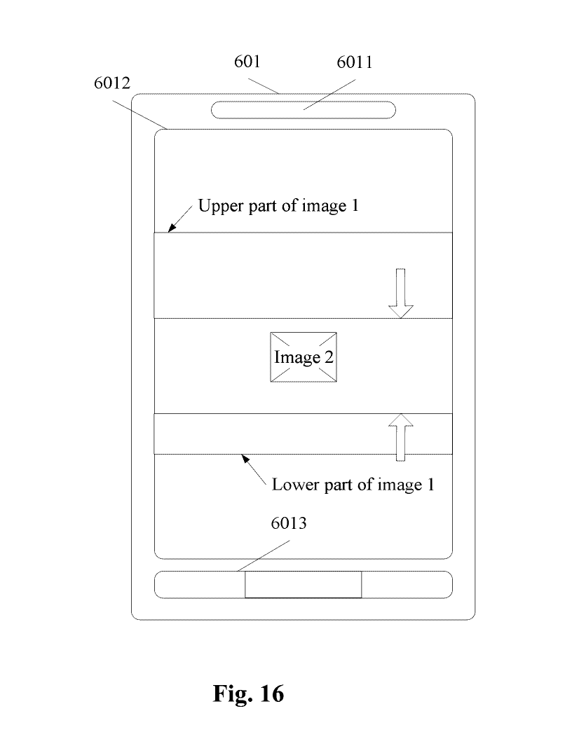

As shown in FIGS. 15 and 16, otherwise, a the length of an operation path of a finger below is greater than a length of the operation path of a finger above, it is automatically switched to the previous picture of the currently displayed picture. In FIGS. 13-16, 601 refers to a fourth portable mobile device, 6011 refers to a speaker on the portable mobile device 601, 6012 refers to a touch control screen on the portable mobile device 601, and 6013 refers to a function key on the portable mobile device 601.

3. It is determined whether the picture to be switched-in is the next picture or the previous picture of the currently displayed picture according to whether the multipoint touch control operation is pinching or pullout.

For example, in the first scenario, the user zooms out the currently displayed picture by a pinching touch operation; and when the pinching touch operation triggers the switching condition, and at this time, since it is detected that the multipoint touch control operation of the user is pinching, it is determined that the picture to be switched-in is the next picture of the currently displayed picture. In the third scenario (i.e. being able to switch the picture via the touch operation of zooming-out, and also being able to switch the picture via the touch operation of zooming-in), the picture switching method of the present embodiment may also be set as when the user switches the currently displayed picture by the touch operation of zooming-out, such as pinching, the switched picture to be switched-in is the next or the previous one of the current picture, and when the user switches the currently displayed picture by the touch operation of zooming-in, such as pullout, a new picture switched is the previous or the next one of the currently displayed picture

By means of setting a switching picture to enter a screen of the present embodiment, diversified visual effects can be produced, and user experience is improved.

In order to further improve the user experience, the picture switching method of the present embodiment of the disclosure may further include: a step of determining whether there is a picture to be switched-in, and when there is the picture to be switched-in and a pre-set picture switching condition is satisfied, performing picture switching, and if there is no the picture to be switched-in, performing no picture switching.

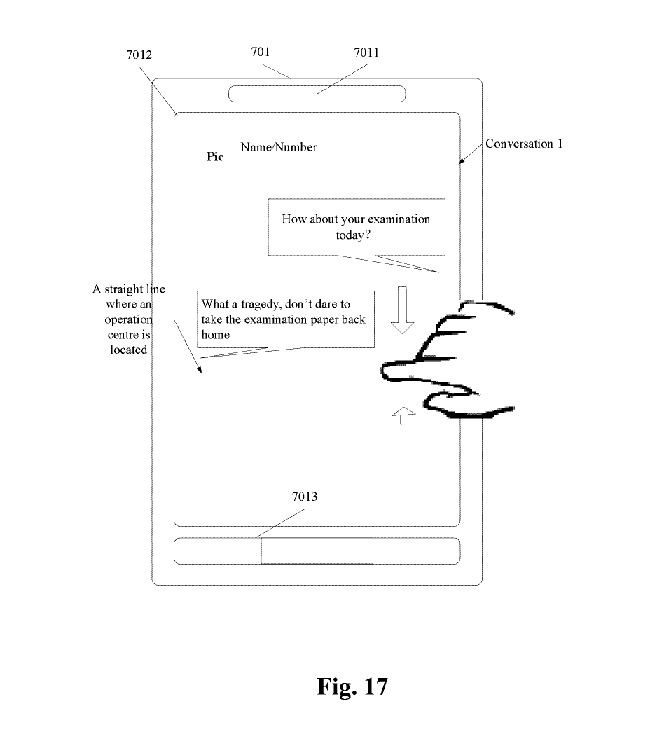

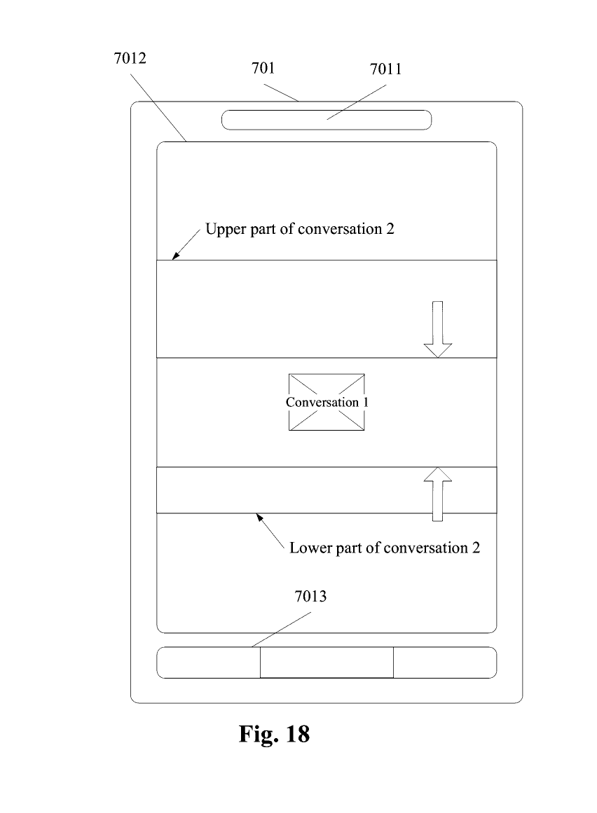

The object switching method of the disclosure may also be applicable to the switching of an information page. For example, when the object of the disclosure is a short message page, and when a user browses a currently displayed short message conversation page 1, the user triggers an object switching condition according to the switching method of the disclosure. As shown in FIGS. 17 and 18, the user performs a pinching touch operation of zooming out the short message conversation page 1, and when the zooming-out proportion of the short message conversation page 1 corresponding to the pinching touch operation satisfies a pre-set proportion threshold value, two constituent parts of a short message conversation page 2 enter a touch screen according to the direction of finger pinching, and are combined into the short message conversation page 2 in an operation central line of the user and are displayed. The method for the short message conversation page 2 entering the touch screen may refer to the method above for the picture 1 or 2 entering the touch screen, for example, the short message page 2 may be divided into two parts in a corresponding proportion according to the proportion of dividing the short message conversation page 1 by the operation central line, and then enter the touch screen according to the direction of a touch operation of user fingers for display. Here, the information page switching condition and the switching method are not limited to the method introduced in FIGS. 17 and 18, and all the switching conditions and switching methods of the above-mentioned pictures can be applicable to the switching of information pages. In FIGS. 17 and 18, 701 refers to a fifth portable mobile device, 7011 refers to a speaker on the portable mobile device 701, 7012 refers to a touch control screen on the portable mobile device 701, and 7013 refers to a function key on the portable mobile device 701.

Most of the parts above introduce the switching process in the case of picture zooming-out, which is similar with a zooming-out operation. According to the core concept of the disclosure, picture switching may also be performed via a zooming-in operation, and when the zooming-in operation exceeds a certain threshold value of picture zooming-in, such as an upper limit of zooming-in, the picture switching is started, and it is judged to switch to the previous picture or the next picture through information, such as an operation location or the length of an operation path of user fingers, when the switching is triggered, display of a visual effect of switching is controlled. Because of the similarity with the principle of a zooming-out operation, reference can fully be made to the previous introduction to the present embodiment, and no much further discussion is performed herein.

### Embodiment II

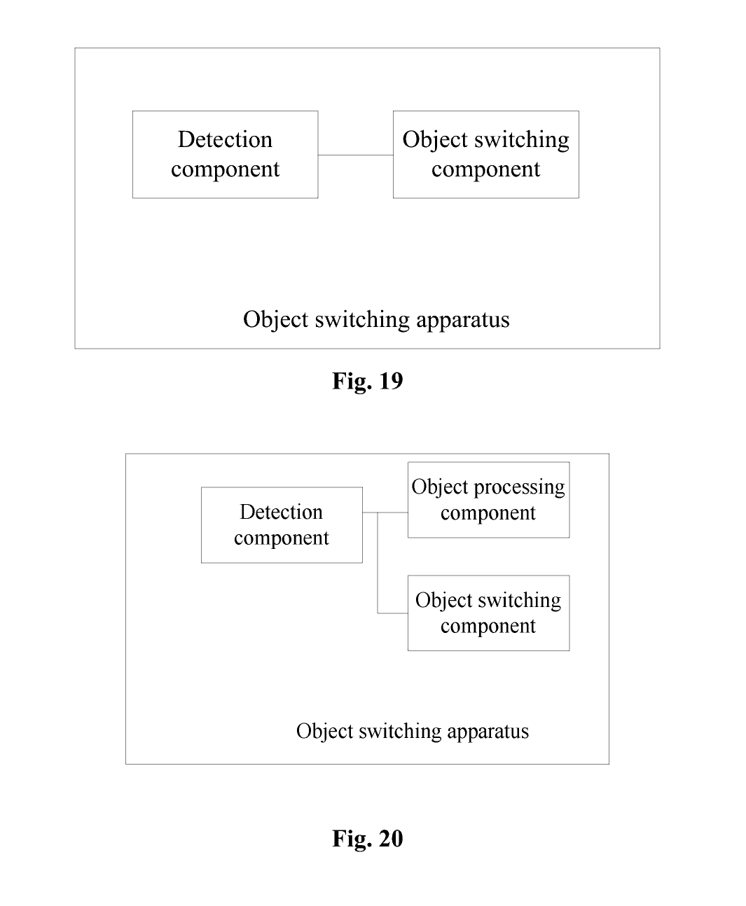

The present embodiment also introduces the object switching apparatus of the disclosure by taking the object as a picture. As shown in FIG. 19, the present embodiment provides an object switching apparatus, including: a detection component and an object switching component,

wherein the detection component is configured to detect, on a picture display interface, that a user performs a multipoint touch control operation of zooming out and/or zooming in a currently displayed picture on a touch screen; and

the object switching component is configured to judge whether the multipoint touch control operation satisfies a pre-set picture switching condition, and when the multipoint touch control operation satisfies the pre-set picture switching condition, switch the currently displayed picture.

The object switching apparatus of the present embodiment may switch a picture by using a multipoint touch control operation used for zooming-out and/or zooming-in, so that a user switches the picture without switching an operation mode, thereby improving the experience of the user browsing the picture.

As shown in FIG. 20, the object switching apparatus of the present embodiment may further include an object processing component, wherein the object processing component is configured to perform zooming-out and/or zooming-in processing for the currently displayed picture according to the multipoint touch control operation; and the object switching component is configured to judge whether the multipoint touch control operation satisfies the pre-set picture switching condition in the process that the object processing component performs the zooming-out and/or zooming-in processing for the currently displayed picture.

The object switching apparatus of FIG. 20 may switch a picture while zooming out and/or zooming in the picture, which not only satisfies the demand of a user for zooming out the picture, but also satisfies the demand for switching the picture.

In an example embodiment, the multipoint touch control operation in the present embodiment is a touch operation where the user contacts with the touch screen via at least two fingers, and zooms out and/or zooms in the currently displayed picture on the touch screen by pinching and/or pullout.

The object switching apparatus of the present embodiment may detect whether a touch operation of pinching and/or pullout used for zooming-out and/or zooming-in satisfies a switching condition, and when the touch operation of pinching and/or pullout used for zooming-out and/or zooming-in satisfies the switching condition, a picture is switched. The object switching apparatus of the present embodiment may switch the picture under a multipoint touch control operation in the condition that a user does not need to switch to a single-point touch control operation for completing the switch of the picture, thereby improving the convenience for user operation.

In an example embodiment, the pre-set picture switching condition is one of the following three switching conditions, or a combination of at least two of the following three switching conditions:

the first one, operating frequency of the multipoint touch control operation being within a pre-set frequency range;

the second one, a zooming-out proportion and/or zooming-in proportion corresponding to the multipoint touch control operation being within a pre-set proportion range; and

the third one, the number of operation times of the multipoint touch control operation being within a pre-set range of the number of times.

The object switching apparatus of the present embodiment may judge whether it is necessary to switch a picture according to one of the above-mentioned three switching conditions, and may also judge whether it is necessary to switch a picture according to two of the three switching conditions or a combination of the three switching conditions.

In an example embodiment, the object switching component is configured to:

divide the picture to be switched-in into at least two constituent parts, enable each of constituent parts of the picture to be switched-in to enter the touch screen according to a first per-set manner, and to be combined into a picture and displayed;

or

enable a complete picture to be switched-in to enter the touch screen according to a second per-set manner and to be displayed;

or

enable a picture to be switched-in to be displayed in a manner that the picture to be switched-in is gradually zoomed in from one point on the touch screen.

In an example embodiment, the first per-set manner includes: the each of constituent parts of the picture to be switched-in entering the touch screen according to a direction of the multipoint touch control operation, and being combined into a picture and displayed.

The second per-set manner includes: the complete picture to be switched-in entering the touch screen according to a direction of the multipoint touch control operation and being displayed.

In an example embodiment, the multipoint touch control operation is a touch operation where the user contacts with the touch screen via at least two fingers, and zooms out and/or zooms in the currently displayed picture on the touch screen by pinching and/or pullout; and the object switching component is configured to:

detect a central line of the touch operation of pinching and/or pullout, acquire a proportion value between two parts of the currently displayed picture which are divided by the central line, and divide the picture to be switched-in into two constituent parts in a corresponding proportion according to the proportion value;

or

detect locations of points that the fingers of the user contact with the touch screen, and divide the picture to be switched-in into two constituent parts in a corresponding proportion according to the locations of the points;

or

detect a length of a touch path where the fingers of the user pinch and/or pull out on the touch screen, and divide the picture to be switched-in into two constituent parts in a corresponding proportion according to the length of the touch path; and

enable the two constituent parts of the picture to be switched-in to enter the touch screen respectively according to the direction consistent with a pinching and/or pullout direction and to be displayed.

In an example embodiment, the multipoint touch control operation is a touch operation where the user contacts with the touch screen via at least two fingers and zooms out and/or zooms in the currently displayed picture on the touch screen by pinching and/or pullout. The object switching component is further configured to detect the location of the points that the fingers of the user contact with the touch screen, and determine whether the picture to be switched-in is the next picture or the previous picture of the currently displayed picture according to the locations of the points; or detect the length of a touch path where the fingers of the user pinch and/or pull out on the touch screen, and determine whether the picture to be switched-in is the next picture or the previous picture of the currently displayed picture according to the length of the touch path; or determine whether the picture to be switched-in is the next picture or the previous picture of the currently displayed picture according to whether the multipoint touch control operation is pinching or pullout.

The working process of various components of the object switching apparatus of the present embodiment may refer to the relevant description of the method steps of Embodiment I. The object switching apparatus of the present embodiment can enable a user to directly switch a picture without switching to single-point touch control when zooming out and/or zooming in a picture, so that the operations related with picture browsing of the user are more smooth, fast and convenient. For example, when a user adopts a multipoint touch control operation to zoom in a currently displayed picture, when the multipoint touch control operation satisfies a pre-set operation, the picture will be switched, such that it is not necessary for the user to perform switching from multipoint touch control to single-point touch control to switch the picture. Meanwhile, the use of the switching method of the present embodiment of the disclosure can avoid the problem that a misoperation is caused due to the same operation between both of picture local part dragging and inter-picture switching. Compared with traditional picture switching methods, the picture switching method of the disclosure can improve the convenience for the user to operate a picture and improve the experience when browsing the picture.

The object switching apparatus of the present embodiment is not only suitable for switching of a picture, but also suitable for switching of a text or an information page.

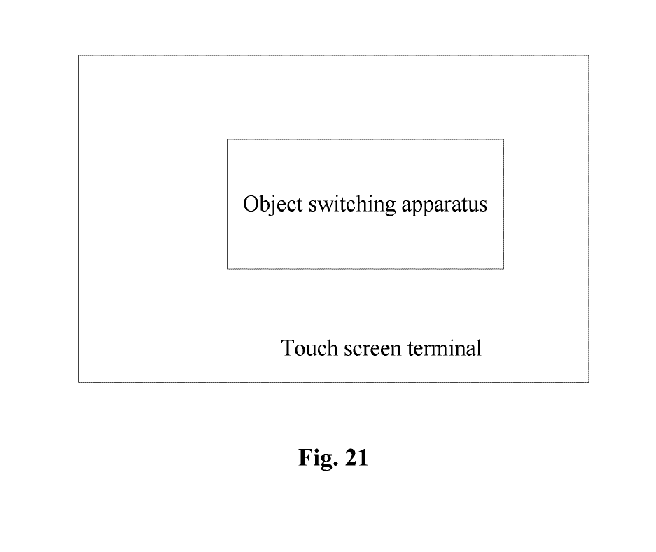

As shown in FIG. 21, the present embodiment further provides a touch screen terminal, including: the above-mentioned object switching apparatus, wherein a detection component in the object switching apparatus detects, on an object display interface, that a user performs a multipoint touch control operation of zooming out and/or zooming in a currently displayed object on a touch screen; and an object switching component in the object switching apparatus judges whether the multipoint touch control operation satisfies a pre-set object switching condition, and when the multipoint touch control operation satisfies the pre-set object switching condition, switches the currently displayed object.

The touch screen terminal of the present embodiment can enable a user to switch a picture without switching a touch control operation when browsing the picture, thereby improving the convenience for the user to operate a picture and improve the experience when browsing the picture.

### INDUSTRIAL APPLICABILITY

Through the technical solution provided by the disclosure, the user can realize object switching via the multipoint touch control operation when browsing the object, and thus it is not necessary to switch to a single-point touch control operation to realize the object switching. In particular, the technical solution can enable the user to switch the picture without switching a touch control operation when browsing the picture, thereby improving the convenience for the user to operate a picture and improve the experience when browsing the picture.

The above-mentioned contents are further detailed description made to the disclosure with reference to specific embodiments, and the specific embodiments of the disclosure cannot be considered as limited to the description. To those skilled in the art to which the disclosure belongs, several simple derivations or substitutions can further be made without departing from the concept of the disclosure, and shall all be regarded as being within the protection scope of the disclosure.

1. An object switching method, comprising:
detecting, on an object display interface, that a user performs a multipoint touch control operation of zooming out and/or zooming in a currently displayed object on a touch screen; and
judging whether the multipoint touch control operation satisfies a pre-set object switching condition, and when the multipoint touch control operation satisfies the pre-set object switching condition, switching the currently displayed object.

2. The object switching method as claimed in claim 1, further comprising: performing zooming-out and/or zooming-in processing for the currently displayed object according to the multipoint touch control operation; wherein judging whether the multipoint touch control operation satisfies the pre-set object switching condition is performed in the process of performing zooming-out and/or zooming-in processing for the currently displayed object according to the multipoint touch control operation.

3. The object switching method as claimed in claim 1, wherein the pre-set object switching condition is one of the following three switching conditions, or a combination of at least two of the following three switching conditions:
a first one, operating frequency of the multipoint touch control operation being within a pre-set frequency range;
a second one, a zooming-out proportion and/or zooming-in proportion corresponding to the multipoint touch control operation being within a pre-set proportion range; and
a third one, the number of operation times of the multipoint touch control operation being within a pre-set range of the number of times.

4. The object switching method as claimed in claim 1, wherein switching the currently displayed object comprises:
dividing an object to be switched-in into at least two constituent parts, each of constituent parts of the object to be switched-in entering the touch screen according to a first per-set manner, and being combined into an object and displayed;
or
a complete object to be switched-in entering the touch screen according to a second per-set manner and being displayed;
or
an object to be switched-in being displayed in a manner that the object to be switched-in is gradually zoomed in from one point on the touch screen.

5. The object switching method as claimed in claim 4, wherein
the first per-set manner comprises: the each of constituent parts of the object to be switched-in entering the touch screen according to a direction of the multipoint touch control operation, and being combined into an object and displayed; and
the second per-set manner comprises: the complete object to be switched-in entering the touch screen according to a direction of the multipoint touch control operation and being displayed.

6. The object switching method as claimed in claim 4, wherein the multipoint touch control operation is a touch operation where the user contacts with the touch screen via at least two fingers, and zooms out and/or zooms in the currently displayed object on the touch screen by pinching and/or pullout; and dividing the object to be switched-in into two constituent parts comprises:
detecting a central line of the touch operation of pinching and/or pullout, acquiring a proportion value between two parts of the currently displayed object which are divided by the central line and dividing the object to be switched-in into two constituent parts in a corresponding proportion according to the proportion value;
or
detecting locations of points that the fingers of the user contact with the touch screen, and dividing the object to be switched-in into two constituent parts in a corresponding proportion according to the locations of the points;
or
detecting a length of a touch path where the fingers of the user pinch and/or pull out on the touch screen, and dividing the object to be switched-in into two constituent parts in a corresponding proportion according to the length of the touch path.

7. The object switching method as claimed in claim 1, wherein the multipoint touch control operation is a touch operation where the user contacts with the touch screen via at least two fingers, and zooms out and/or zooms in the currently displayed object on the touch screen by pinching and/or pullout; before switching the currently displayed object, the method further comprises: determining whether an object to be switched-in is a next object or a previous object of the currently displayed object, comprising:
detecting locations of points that the fingers of the user contact with the touch screen, and determining whether the object to be switched-in is the next object or the previous object of the currently displayed object according to the locations of the points;
or
detecting a length of a touch path where the fingers of the user pinch and/or pull out on the touch screen, and determining whether the object to be switched-in is the next object or the previous object of the currently displayed object according to the length of the touch path;
or
determining whether the object to be switched-in is the next object or the previous object of the currently displayed object according to whether the multipoint touch control operation is pinching or pullout.

8. The object switching method as claimed in claim 1, wherein the object comprises: a picture, a document or an information display page.

9. An object switching apparatus, comprising: a detection component and an object switching component,
wherein the detection component is configured to detect, on an object display interface, that a user performs a multipoint touch control operation of zooming out and/or zooming in a currently displayed object on a touch screen; and
the object switching component is configured to judge whether the multipoint touch control operation satisfies a pre-set object switching condition, and when the multipoint touch control operation satisfies the pre-set object switching condition, switch the currently displayed object.

10. The object switching apparatus as claimed in claim 9, wherein the apparatus further comprises: an object processing component,
wherein the object processing component is configured to perform zooming-out and/or zooming-in processing for the currently displayed object according to the multipoint touch control operation; and
the object switching component is configured to judge whether the multipoint touch control operation satisfies the pre-set object switching condition in the process that the object processing component performs the zooming-out and/or zooming-in processing for the currently displayed object.

11. The object switching apparatus as claimed in claim 9, wherein the pre-set object switching condition is one of the following three switching conditions, or a combination of at least two of the following three switching conditions:
a first one, operating frequency of the multipoint touch control operation being within a pre-set frequency range;
a second one, a zooming-out proportion and/or zooming-in proportion corresponding to the multipoint touch control operation being within a pre-set proportion range; and
a third one, the number of operation times of the multipoint touch control operation being within a pre-set range of the number of times.

12. The object switching apparatus as claimed in claim 9, wherein the object switching component is configured to:
divide an object to be switched-in into at least two constituent parts, enable each of constituent parts of the object to be switched-in to enter the touch screen according to a first per-set manner, and to be combined into an object and displayed;
or
enable a complete object to be switched-in to enter the touch screen according to a second per-set manner and to be displayed;
or
enable an object to be switched-in to be displayed in a manner that the object to be switched-in is gradually zoomed in from one point on the touch screen.

13. The object switching apparatus as claimed in claim 12, wherein
the first per-set manner comprises: the each of constituent parts of the object to be switched-in entering the touch screen according to a direction of the multipoint touch control operation, and being combined into an object and displayed; and
the second per-set manner comprises: the complete object to be switched-in entering the touch screen according to a direction of the multipoint touch control operation and being displayed.

14. The object switching apparatus as claimed in claim 12, wherein the multipoint touch control operation is a touch operation where the user contacts with the touch screen via at least two fingers, and zooms out and/or zooms in the currently displayed object on the touch screen by pinching and/or pullout; and
the object switching component is configured to:
detect a central line of the touch operation of pinching and/or pullout, acquire a proportion value between two parts of the currently displayed object which are divided by the central line, and divide the object to be switched-in into two constituent parts in a corresponding proportion according to the proportion value;
or
detect locations of points that the fingers of the user contact with the touch screen, and divide the object to be switched-in into two constituent parts in a corresponding proportion according to the locations of the points;
or
detect a length of a touch path where the fingers of the user pinch and/or pull out on the touch screen, and divide the object to be switched-in into two constituent parts in a corresponding proportion according to the length of the touch path.

15. The object switching apparatus as claimed in claim 9, wherein the multipoint touch control operation is a touch operation where the user contacts with the touch screen via at least two fingers, and zooms out and/or zooms in the currently displayed object on the touch screen by pinching and/or pullout; and
the object switching component is further configured to detect locations of points that the fingers of the user contact with the touch screen, and determine whether the object to be switched-in is a next object or a previous object of the currently displayed object according to the locations of the points; or detect a length of a touch path where the fingers of the user pinch and/or pull out on the touch screen, and determine whether the object to be switched-in is a next object or a previous object of the currently displayed object according to the length of the touch path; or determine whether the object to be switched-in is a next object or a previous object of the currently displayed object according to whether the multipoint touch control operation is pinching or pullout.

16. A touch screen terminal, comprising the object switching apparatus as claimed in claim 9.

17. The object switching method as claimed in claim 2, wherein switching the currently displayed object comprises:
dividing an object to be switched-in into at least two constituent parts, each of constituent parts of the object to be switched-in entering the touch screen according to a first per-set manner, and being combined into an object and displayed;
or
a complete object to be switched-in entering the touch screen according to a second per-set manner and being displayed;
or
an object to be switched-in being displayed in a manner that the object to be switched-in is gradually zoomed in from one point on the touch screen.

18. The object switching method as claimed in claim 17, wherein the multipoint touch control operation is a touch operation where the user contacts with the touch screen via at least two fingers, and zooms out and/or zooms in the currently displayed object on the touch screen by pinching and/or pullout; and dividing the object to be switched-in into two constituent parts comprises:
detecting a central line of the touch operation of pinching and/or pullout, acquiring a proportion value between two parts of the currently displayed object which are divided by the central line and dividing the object to be switched-in into two constituent parts in a corresponding proportion according to the proportion value;
or
detecting locations of points that the fingers of the user contact with the touch screen, and dividing the object to be switched-in into two constituent parts in a corresponding proportion according to the locations of the points;
or
detecting a length of a touch path where the fingers of the user pinch and/or pull out on the touch screen, and dividing the object to be switched-in into two constituent parts in a corresponding proportion according to the length of the touch path.

19. The object switching apparatus as claimed in claim 10, wherein the object switching component is configured to:
divide an object to be switched-in into at least two constituent parts, enable each of constituent parts of the object to be switched-in to enter the touch screen according to a first per-set manner, and to be combined into an object and displayed;
or
enable a complete object to be switched-in to enter the touch screen according to a second per-set manner and to be displayed;
or
enable an object to be switched-in to be displayed in a manner that the object to be switched-in is gradually zoomed in from one point on the touch screen.

20. The object switching apparatus as claimed in claim 19, wherein the multipoint touch control operation is a touch operation where the user contacts with the touch screen via at least two fingers, and zooms out and/or zooms in the currently displayed object on the touch screen by pinching and/or pullout; and
the object switching component is configured to:
detect a central line of the touch operation of pinching and/or pullout, acquire a proportion value between two parts of the currently displayed object which are divided by the central line, and divide the object to be switched-in into two constituent parts in a corresponding proportion according to the proportion value;
or
detect locations of points that the fingers of the user contact with the touch screen, and divide the object to be switched-in into two constituent parts in a corresponding proportion according to the locations of the points;
or
detect a length of a touch path where the fingers of the user pinch and/or pull out on the touch screen, and divide the object to be switched-in into two constituent parts in a corresponding proportion according to the length of the touch path.
